(19) United States
(12) Patent Application Publication
(10) Pub. No.: US 2015/0110459 A1
(43) Pub. Date: Apr. 23, 2015

(54) SYSTEMS, METHODS AND DEVICES THAT ALLOW SECURITY AND SECURITY GUARD FUNCTIONS TO BE PERFORMED USING AN INTEGRATED SYSTEM AND MOBILE DEVICES

(71) Applicant: GOMOBILE SECURITY SOLUTIONS PTE LTD, Singapore (SG)

(72) Inventor: Charles George St. John Reed, Singapore (SG)

(21) Appl. No.: 14/515,432

(22) Filed: Oct. 15, 2014

(30) Foreign Application Priority Data
Oct. 18, 2013 (SG) 201307850-6

(51) Int. Cl. H04N 7/18; H04W 4/02; H04N 5/77

(52) U.S. Cl. CPC H04N 7/181; H04N 5/77; H04W 4/025
USPC 386/223; 348/159; 455/456.1

(57) ABSTRACT

This disclosure is directed at system which integrates many of the functions of existing security and security guard systems into a single integrated system, while adding new functions and increased functionality through the centralization of the systems. The present system uses a server based system to provide the backbone of a system which takes input and performs its functions through network connection through a web portal, to an application on mobile devices, to CCTV and/or DVR devices, and to any other network enabled device which is connected to the system. One major function of the system disclosed allows CCTV and/or DVR systems to be networked into the server system, allowing the server to store, document, and log the video and photos, along with any video and photos from any mobile devices, such as camera phones, which are networked into the system. Another feature, via an application on a mobile device, is intended to both perform a number of functions essential to guard duty, such as communication, surveillance, incident reporting, and patrol routing function, as well as to allow management to monitor guards by tracking their patrol routes and logging events and recordings. Additionally, the present invention allows a property's management, staff, residents and guests to view selected CCTV camera video and/or images on a mobile device.

### FIELD OF THE INVENTION

The subject invention relates to the use of mobile electronic devices and server systems to accomplish security related tasks such as CCTV monitoring, security guard functions, and communication.

### BACKGROUND OF THE INVENTION

Security guards and security systems are as important now in the modern age as they have been historically, but many of the systems used by security teams seem archaic compared to many of the technological marvels they guard. Security guards today often rely on walkie-talkies or phones to communicate with each other. When an incident occurs they often fill out a paper form to put in a filing system. They may use punch cards, sign in boards to sign in or clocking devices on patrol routes.

The Closed Circuit Television (CCTV) systems used by many businesses, too, may have drawback from their age. Even if modern Digital Video Recorders (DVRs) are used, when a video file needs to be pulled to file with an incident, it may have to be burned on to a physical media such as a DVD and filed with the paper incident report.

These limitations come at a time when many of the guards themselves carry around smartphones capable of photo and video capture, but even if a photo is taken with a personal device, it would not necessarily be easy to associate it with a report or a guard's log.

These limitations affect guard management too, as many guard managers go to great lengths to try to make sure that the guards themselves are actually performing their duties, especially on graveyard shifts when accountability might be scarce. What is needed, then, is a new system which takes advantage of new technology to solve the old problems of security guards and security systems.

In addition to security guard services, there is a need in properties by management, staff, residents and guest to have access selective to CCTV system to view both video and images. Currently, those images are only available to the security staff of the property.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to integrate many of the functions of security guard functions and security devices into a network based server replacing and improving many of the old systems in the field.

It is also an object of the present invention to a server system to control, store, process, and deliver CCTV and DVR recordings and live streams of video and photos via a web portal and a mobile device application.

It is also an object of the present invention to allow a security guard to use a mobile device such as a smartphone to perform many of their job related functions such as patrol routing, surveillance, reporting, recording, and communications.

It is also an object of the present invention to allow guard management to have oversight and accountability over many of the job functions of a security guard through monitoring of the guards mobile device.

It is also an object of the present invention to allow property management, staff, residents and guests the ability to selectively monitor CCTV cameras using a mobile device.

### SUMMARY OF THE INVENTION

This disclosure is directed at system which integrates many of the functions of existing security and security guard systems into a single integrated system, while adding new functions and increased functionality through the centralization of the systems. The present system uses a server based system to provide the backbone of a system which performs tasks necessary for security surveillance, guarding, and guard management. The server system takes input and performs its functions through network connection through a web portal, to an application on mobile devices, to CCTV and/or DVR devices, and to any other network enabled device which is connected to the system.

One major function of the system disclosed allows CCTV and/or DVR systems to be networked into the server system, allowing the server to store, document, and log the video and photos, along with any video and photos from any mobile devices, such as camera phones, which are networked into the system. These files can be searched and viewed wither live or as recordings, and the recordings can be attached to event reports or other user or automatically generated files in the server database.

Another major aspect of the system is the server's connection to mobile devices via an installed application or web access, which are accessed by security guards while performing their duties. This feature is intended to both perform a number of functions essential to guard duty, such as communication, surveillance, incident reporting, and patrol routing function, as well as to allow management to monitor guards by tracking their patrol routes and logging events and recordings.

Overall, the integration of these features and others disclosed herein demonstrate a major improvement over the current state of the art for security services through flexibility, ease of use, and resilience.

Finally, the invention disclosed herein provides a convenient and easy to use method of CCTV camera monitoring by guests, residents, staff and management of a property.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a block diagram of an electronic device according to one embodiment of the invention.

FIG. 2 is a schematic diagram of a system in which a server performs a number of security function by interfacing between a number of devices and users according to one embodiment of the invention.

FIG. 3 is a schematic diagram of a system in which a server performs delivers video and photos from security system sources to various users acceding to one embodiment of the invention

FIG. 4 is a schematic diagram of a system in which a mobile device allows a user to perform a number of security guard tasks using an application on a mobile device according to one embodiment of the invention.

FIG. 5 is a representation of a screen of the software depicting a user hierarchy according to one embodiment of the invention.

FIG. 6 is a representation of a screen of the software depicting guard route stops according to one embodiment of the invention.

FIG. 7 is a representation of a screen of the mobile device application depicting a login screen according to one embodiment of the invention.

FIG. 8 is a representation of a screen of the mobile device application depicting camera stream access according to one embodiment of the invention.

FIG. 9 is a representation of a screen of the mobile device application depicting a distress button according to one embodiment of the invention.

FIG. 10 is a representation of screens of the mobile device application depicting an incident report according to one embodiment of the invention.

FIG. 11 is a representation of a screen of the mobile device application depicting an alert list according to one embodiment of the invention.

FIG. 12 is a representation of screens of the mobile device application depicting a set security guard patrol according to one embodiment of the invention.

FIG. 13 is a representation of screens of the mobile device application depicting QR code scanning at a guard stop according to one embodiment of the invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this detailed description section.

It will be apparent to those of ordinary skill in the art that although the systems and methods of this invention are often embodied in this description as applying to hotels, hotel rooms, and hotel guests, that the same systems and methods can be applied to other fields as well, and that the use in this document of these terms is used for simplicity rather than as a limitation of the scope of the invention. For instance the guest communication center herein described is an invention not just for hotels but for any facility, such as homes, condominiums, apartment complexes, cruise ships, office buildings or other structures or businesses. Likewise, all of the devices, methods, and systems herein described can be used for any of these businesses and locations as well. Therefore the terms hotel, hotel room, and guest should not be read as limiting the scope of this invention to the hospitality industry.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” “electronic device” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Near Field Communications (NFC) link, Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, Wi-Fi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (CPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

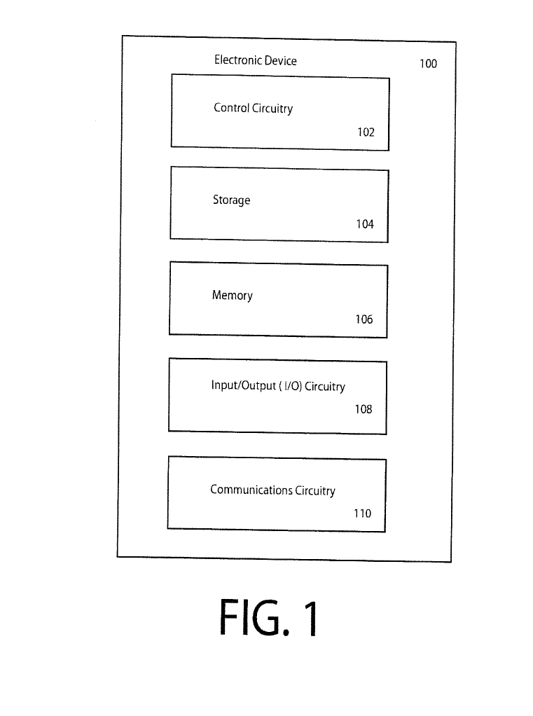

FIG. 1 is a schematic view of an illustrative electronic device for providing an application operative to interface with a hotel system in accordance with some embodiments of the invention. Electronic device 100 can include control circuitry 102, storage 104, memory 106, I/O circuitry 108, and communications circuitry 110. In some embodiments, one or more of the components of electronic device 100 can be combined or omitted. In some embodiments, electronic device 100 can include other components not combined or included in those shown in FIG. 1 (e.g., motion detection components, a power supply such as a battery or kinetics, a display, a bus, a positioning system. or an input mechanism), or several instances of the components shown in FIG. 1. For the sake of simplicity, only one of each of the components is shown in FIG. 1.

Electronic device 100 can include any suitable type of electronic device. For example, electronic device 100 can include a portable electronic device that the user may hold in his or her hand, such as a digital media player, a personal e-mail device, a personal data assistant (“PDA”), a cellular telephone, a handheld gaming device, and a digital camera. As another example, electronic device 100 can include a larger portable electronic device, such as a laptop computer. As yet another example, electronic device 100 can include a substantially fixed electronic device, such as a desktop computer or a docking station.

Control circuitry 102 can include any processing circuitry or processor operative to control the operations and performance of electronic device 100. For example, control circuitry 102 can be used to run operating system applications, firmware applications, media playback applications, media editing applications, or any other application. In some embodiments, control circuitry 102 can drive a display and process inputs received from a user interface.

Storage 104 can include, for example, one or more storage mediums including a hard-drive, solid state drive, flash memory, permanent memory such as ROM. any other suitable type of storage component, or any combination thereof. Storage 104 can store, for example, media data (e.g., music and video files), application data (e.g., for implementing functions on electronic device 100), firmware, user preference information data (e.g. media playback preferences), authentication information (e.g. libraries of data associated with authorized users), lifestyle information data (e.g., food preferences. exercise information data (e.g., information obtained by exercise monitoring equipment), transaction information data (e.g., information such as credit card information), wireless connection information data (e.g., information that can enable electronic device 100 to establish a wireless connection), subscription information data (e.g. information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as RAM and/or one or more different types of memory used for temporally storing data. In some embodiments, memory 106 can also be used for storing data used to operate electronic device applications, or any other type of data that can be stored in storage 104. In some embodiments, memory 106 and storage 104 can be combined as a single storage medium.

I/O Circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 1 as a single component of electronic device 100, several instances of I/O circuitry 108 can be included in electronic device 100.

Electronic device 100 can include any suitable interface or component for allowing a user to provide inputs to I/O circuitry 108. For example, electronic device 100 can include any suitable input mechanism, such as for example, a button, keypad, dial, a click wheel, or a touch screen. In some embodiments, electronic device 100 can include a capacitive or resistive sensing mechanic, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated in electronics device 100. As another example, the display circuitry can include a movable display or a projecting system for providing a display of content on a surface remote from electronic device 100 (e.g., a video projector). In some embodiments, the display circuitry can include a coder/decoder (Codec) to convert digital media data into analog signals. For example, the display circuitry (or other appropriate circuitry within electronic device 100) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, L4 GHz, and 5.6 GHz communication systems), infrared, GSM, GSM plus EDGE, CDMA, quadband, and other cellular protocols, VOW, Near Field Communications (NFC), or any other suitable protocol.

In some embodiments, communications circuitry 110 can be operative to create a communications network using any suitable communications protocol. For example, communications circuitry 110 can create a short-range communications network using a short-range communications protocol to connect to other devices. For example, communications circuitry 110 can be operative to create a local communications network using the Bluetooth® protocol to couple electronic device 100 with a Bluetooth® headset.

Electronic device 100 can include one or more instances of communications circuitry 110 for simultaneously performing several communications operations using different communications networks, although only one is shown in FIG. 1 to avoid overcomplicating the drawing. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

In some embodiments, electronic device 100 can be coupled to a host device for data transfers, synching the communications device, software or firmware updates, providing performance information to a remote source (e.g., providing riding characteristics to a remove server) or performing any other suitable operation that can require electronic device 100 to be coupled to a host device. Several electronic devices 100 can be coupled to a single host device using the host device as a server. Alternatively or additionally, electronic device 100 can be coupled to several host devices (e.g., for each of the plurality of the host devices to serve as a backup for data stored in electronic device 100).

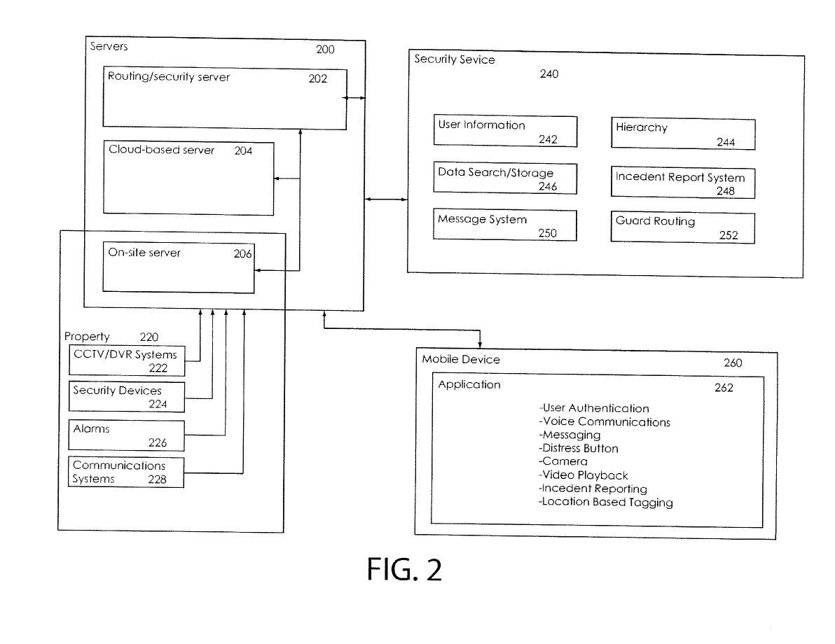

FIG. 2 depicts a system using several types of electronic device 100 such as one or more servers, mobile devices, network storage devices, and cameras, etc. This system depicts a broad view of some embodiments of the invention disclosed herein.

FIG. 2 depicts a system by which many of the functions of a security guard system, such as Closed Circuit Television (CCTV) systems, guard reporting and communicating, guard management, incident reporting, guard tracking and patrol route management and other functions are integrated into a single interconnected system via a server system and network of mobile and fixed electronic devices.

Server 200 is networked server system. In some embodiments server 200 will be an on-site server 206. In some embodiments, server 300 is located off the property. In some embodiments, server 300 is located in the cloud 204 via a hosting server such as Amazon EC2™ cloud hosting. In some embodiments, server system 200 has a separate routing/security server 202 to provide enhanced security. In the preferred embodiment, server 200 is a server system comprised of a combination of local, offsite, and or cloud based systems for the redundancy and flexibility such a system provides. For the purposes of this discloser, the term “server” will be used to describe any or all of the above systems.

In the preferred embodiment, the server 200 will be attached via network connection to a number of devices on a property 220 which together provide a security system or some aspect of a security system.

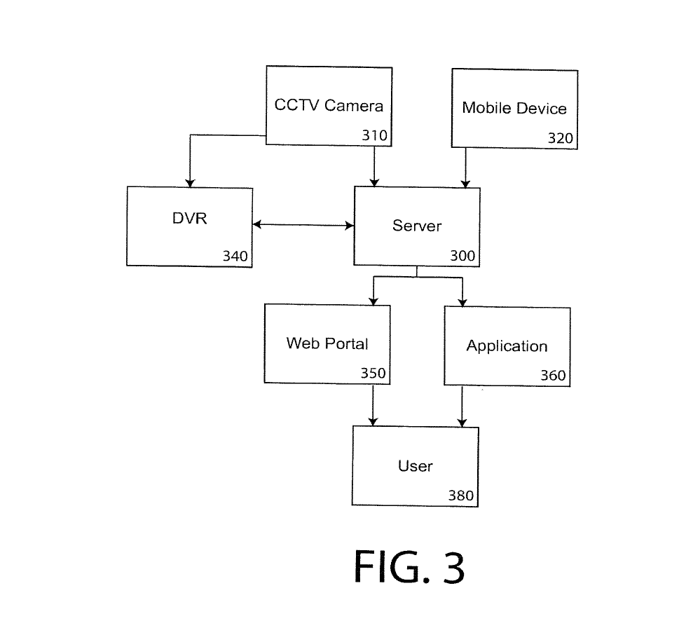

In some embodiments, the server 200 is attached to networked CCTV and/or DVR 222 devices, as described in detail in the section of this disclosure dealing with FIG. 3.

In some embodiments, the server 200 may be attached to other on property devices such as security devices 224, alarms 226, and communications systems 228.

In the preferred embodiment, the server 200 runs software which gives it a number of features for a security service 240. In the preferred embodiment, these features are accessed through a web portal providing server access and through an application which can be installed on mobile devices.

In the preferred embodiment, security service 240 requires user authorization by matching login credentials to stored user information 242. In the preferred embodiment, each user, in addition to the login credentials, will have additional information stored with their user account.

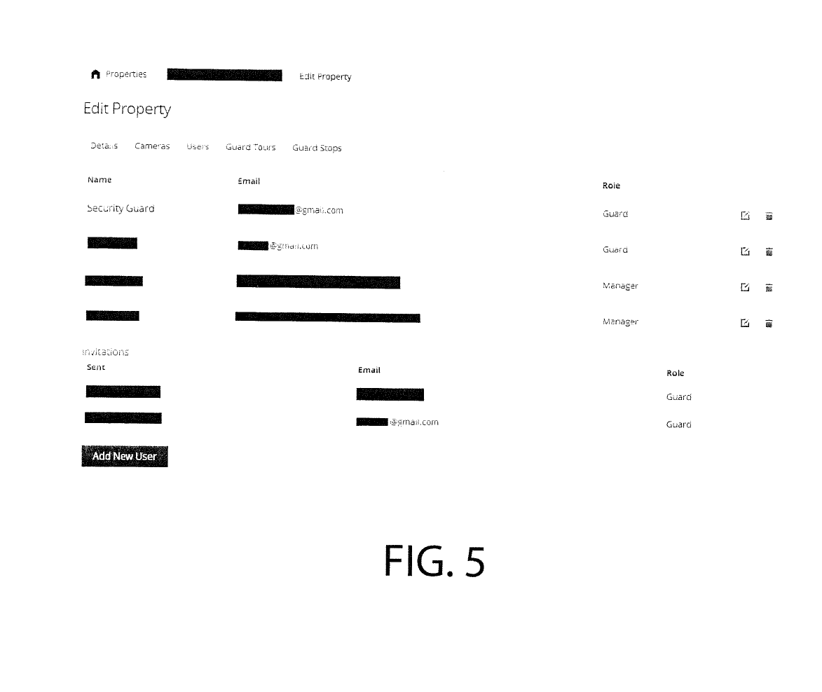

In the preferred embodiment, each user ID will have a level of access in a pre-made hierarchy. 244. The hierarchy 244 provides the security service a device by which to allow users access to some, but not all, of the features and data the server 200 has available to it. For instance, if the user was a property manager, they might be allowed to access all security cameras on their own property, but not other properties, while a guard might only be able to access security cameras on their own route. Possible levels upon which to divide this hierarchy include: Brand, property, areas, sub areas, specific devices. Any of the features disclosed herein may be restricted based on hierarchy or restricted based specifically on a user ID. FIG. 5 depicts an example screen of a user identification and hierarchy chart as it might be run on the server 200.

In some embodiments, the security service 240 will have a data storage and search system 246.

In some embodiments, the security service 240 will have an incident reporting system 248. This system provides a log of events where users can add entries for incidents which occur, such as a theft, and to which data can be attached. For instance, if a theft occurs, a guard may notice the missing item, and use his camera phone to take a picture of location where the item used to be. The log entry can then be associated with the digital recording of the security camera footage during the time or the theft and any and all reports of guards and witnesses.

In some embodiments, the security service 240 has a messaging system 250, allowing messages to be transmitted to specific users, to many users, or hierarchically. This system, in some embodiments, can be used to create “alerts” which may be specific notices to specific groups, and may be sent attached to other data such as a photo. For instance an alert can be sent by a security guard to other active guards of a photo of a suspicious man saying that he tried to access the property and to report if he tries again from a different location.

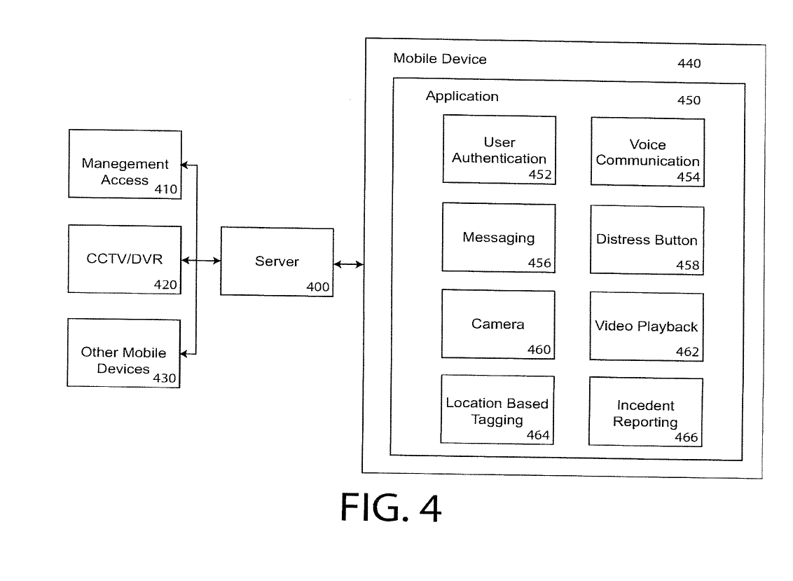

In some embodiments, the security service 240 has a guard routing function in which specific guard patrol routes can be set and monitored my management. Tracking may be accomplished using the guard's mobile device 260, as disclosed in the description of FIG. 4 later in the disclosure.

In the preferred embodiment, the server 200 is attached by a network to mobile devices 260 carried by guards, on which is installed an application 262. The features listed are described in detail in the description of FIG. 4 later in the disclosure.

In the preferred embodiment, mobile device 260 is smartphone or tablet such as an iOS™, Android™ or Windows 8™ device. As the mobile device market develops, however, the current invention contemplates other carried or wearable devices with other operating systems as they become available, with application 262 being written or adapted to the specific operating system or device.

In some embodiments, the mobile device 260 will be a device provided to the guard by the guard service, while in other embodiments, the system may use an application 262 installed on the guards own mobile device 260 such as a previously owned smartphone.

FIG. 3 shows in greater detail the CCTV system depicted more generally in FIG. 2. The system depicted in FIG. 3 allows a server 300 to be attached to one or more networked CCTV cameras 310 and mobile devices 320 with video or image capture ability. In some embodiments, the server 300 can store these images and video files and function as a Digital Video Recorder (DVR). In other embodiments, the CCTV cameras 310 and/or the server 300 may be attached to a distinct DVR system 340. In either case, the server allows user 380 to access the stored data such as recorded or live video streams via a web portal 350 or an application installed on a mobile device 360, allowing. In addition, the server allows incident reports to be made through an interface 390. Each of these components will be described in further detail below.

CCTV camera 310 is a camera which is networked, either through a direct connection to a network, or by a connection to a separate video processor which streams to the network.

In some embodiments the CCTV camera is attached to a DVR system 340 which is attached to the server via network connectivity. In some embodiments, multiple CCTV cameras 310 can be attached to the server 300 via a single DVR system 340. In the preferred embodiment, the server 300 has the flexibility to accept any number of CCTV cameras 310 and/or DVR systems 340.

In some embodiments the CCTV cameras 310 or DVR systems 340 are given a distinct IP address and are authenticated by the server via network security means such as encryption.

In the preferred embodiment, the server 300 has a number of stored details and data pertaining to each of the CCTV cameras 310 and/or DVR systems 340 which may be accessed alone, along with the video data from and individual CCTV camera 310 and/or DVR system 340, or stored as metadata for a video or other file. Such data in the preferred embodiment may include the following: camera/DVR location, property name/location, IP address.

In addition to photos and videos and photos taken by CCTV cameras 310, in some embodiments the server 300 can receive videos and/or photos taken by mobile devices 320 such as those carried by the guards on a specific property. Such input can be user initiated, such as when a guard uses a mobile device 320 in order to record a specific incident, or can be generally streamed, such as from a wirelessly networked wearable camera. In the event such data cannot be uploaded live, it can in any event be uploaded later from a recording on the mobile device 320.

A user 380 may be able to view video, photos, and or other information stored by server 300. The process by which a user 300 is granted access to particular data is detailed later in this disclosure.

In the preferred embodiment, the server 300 will be able to stream video or display photos to a user 380 via a web portal 350 and an application 360 which is installed on a mobile device. Other standard viewing means are envisioned but not described here.

In the preferred embodiment, the server 300 will be able to display video in either a live stream or from a recording. More than one video may be displayed simultaneously via multiple screens and/or split screens. Multiple users 380 may have access to a single file or stream simultaneously and a single user 380 may have simultaneous access to multiple streams and/or files.

In the preferred embodiment server 300 will have a search function so that a User 380 may search for a specific camera, file, or group of files. Search criteria may be based on any stored information such as time/dates of recordings or even more advanced criteria such as a facial recognition analysis of photos and recordings.

In one embodiment of the invention, the video and/or photos from particular CCTV Cameras 310 and/or DVR's 340 are made available by server 300 to a user 380 who, rather than being a security guard, is another recognized user who is given access to a particular set of one or more video streams/recordings. These user may be assigned specific allowances on a case by case basis, a group basis, or based on a hierarchy. as disclosed earlier. To illustrate, types of users who may have access to this and examples of the access they have are: hotel management—entire property, hotel guest—camera covering room entrance, doorman—camera covering working area, restaurant staff—cameras covering restaurant, etc.

The users 380 who are given access to a particular set of video/photos, may access it, as disclosed above, through a web portal, a mobile device application, and/or some other server access means, depending on the embodiment of the invention.

FIG. 4 shows in greater depth the section of FIG. 2 related to the mobile device 262 and the server and application functions which are used by a guard carrying such a mobile device in the preferred embodiment of the invention. The major features of this part of the system shown in FIG. 4, which will be explained in greater detail below, are video/photo capture and playback, voice and text messaging, guard route management and accountability based on location based tagging and incident reporting.

Server 400 is a server which is the same or of the same types as those described above in FIGS. 2 and 3 as server 200 and 300 respectively. As described previously, server 400 has network or direct access or is accessed by management users 410, CCTV/DVR 420, and/or one or more mobile devices 430.

An individual mobile device 440 which is connected to the server via a network means, will in the preferred embodiment have an application 450 installed on it providing a number of features. In other embodiments these features may be provided by other means such as by a web portal using the browser of a mobile device.

In the preferred embodiment, application 450 allows a security guard to access a number of features while simultaneously performing tasks related to management of that guard.

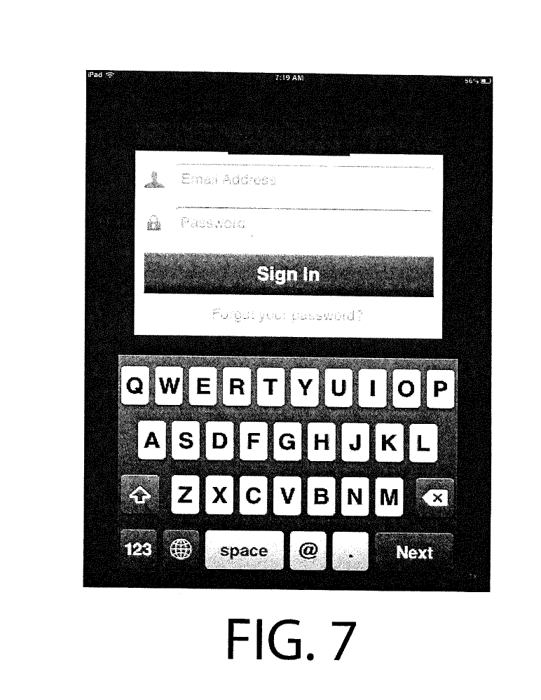

In the preferred embodiments, the server 400 will require identification of the guard through application 450 via a user authentication module 452. Identification of a guard or other user can be based on any number of means, such as login and password identification, device identification, biometric identification, location based identification, or some combination of the above and/or other means. FIG. 7 depicts an example interface for the application showing login window based on email and password.

In the preferred embodiment, once the guard has been positively identified, they will have access to some or all of the features provided by the application which follow.

In some embodiments, the application 450 has a voice communication function 454 which allows the user to communicate live or via recording with other mobile devices in the greater system. This communication can take place via a number of means, such as voice over network telephony (VoIP), or network voice protocol (NVP). Such communications can be set to be routed through the server 400 to connected mobile devices 430, or can be sent directly to those devices through a direct connection or an ad-hoc network. To allow flexibility and stability, the means of connection may be adjustable on the fly depending on signal and connectivity.

In some embodiments, the voice communication may contain either, or may be switched between a send-to-all system reminiscent of traditional walkie-talkie systems and a direct device to device system more like a tradition phone call.

In some embodiments, the server 400 will record some or all of the voice transmissions.

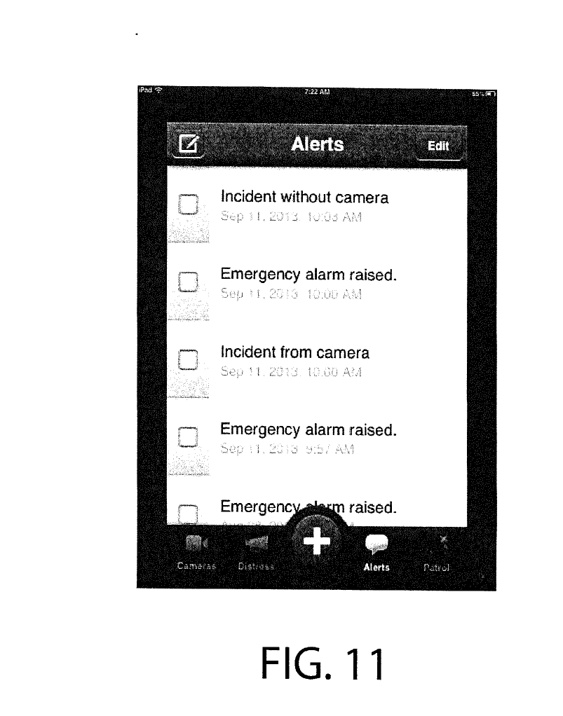

In some embodiments, the application 450 will have a messaging function 456. This function may be an interface to interact with the messaging system described earlier in FIG. 2 and/or may be a point to point messaging system similar to text messaging between guards carried mobile devices. FIG. 11 depicts an example interface for the application where the messages are sample alerts have that have been sent to a particular mobile device.

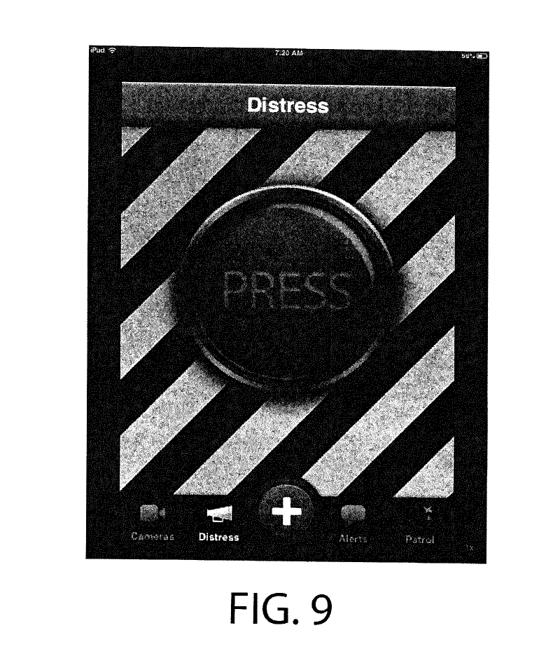

In some embodiments, application 450 will have a distress button 458 feature, which will either be a hard button on the device or an easily accessed button in the application. Once pressed this button may have one or more functions as desired, including: alerting other mobile devices 430, sending out the coordinates of the distress call, triggering a security alert, triggering a security alarm, or calling local authorities. FIG. 9 depicts an example interface for the application showing a distress button.

In some embodiments, application 450 will have the ability to take pictures and/or video with an attached camera 460. As described in FIG. 3, such video and photos may be integrated into the CCTV system and can be used for event reporting. This function of the application, in some embodiments, allows the user to take a photo, then to either approve or discard the photo before it is stored. Videos and photos can be stored on both or either the mobile device or by the server.

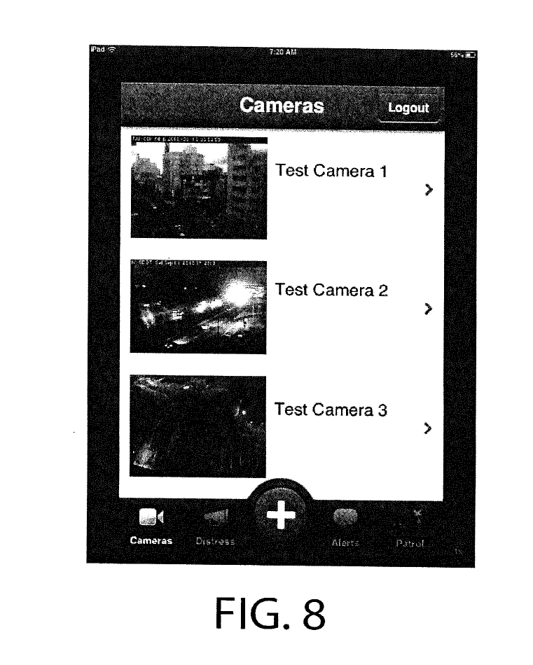

In some embodiments, application 450 will have video playback 462 functionality via server 400 which acts as a means by which video can be either streamed live or brought up from a recording as described in FIG. 3. FIG. 8 depicts an example interface for the application in which 3 camera streams are available.

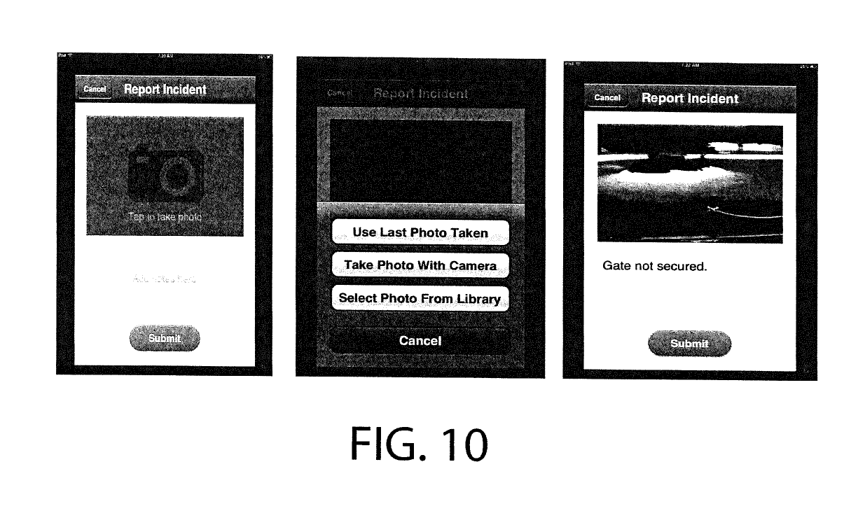

In some embodiments, application 450 will have an interface for incident reporting 466 via either text or voice. This incident reporting will be logged in the system as described in FIG. 2. FIG. 10 depicts an example interface for the application allowing an incident to be reported with both notes and by attaching a picture taken.

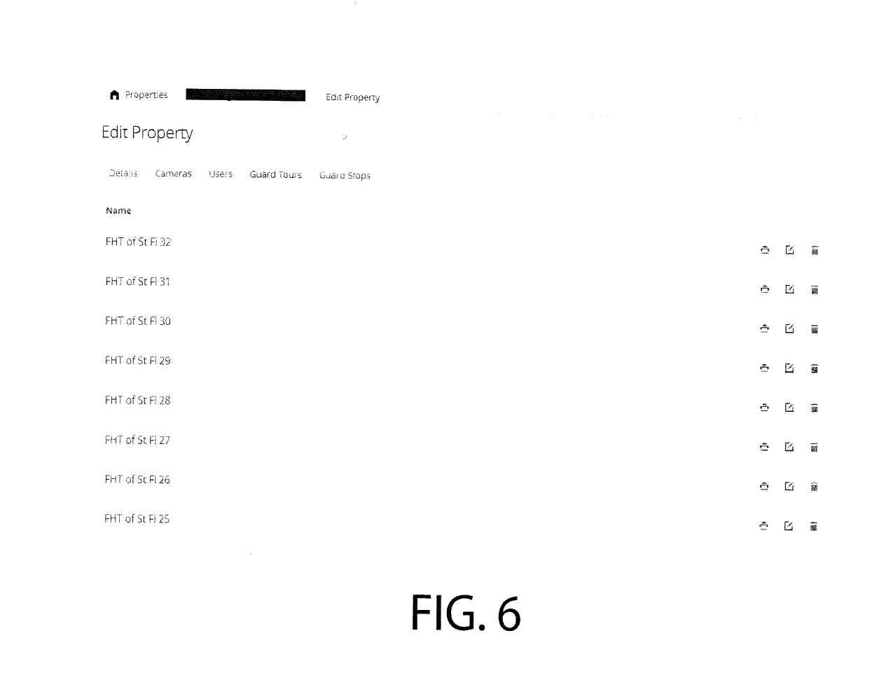

In some embodiments, application 450 will have an ability to enable location based tagging which allows the mobile device to act as means of tracking and managing patrol routes for security guards. In the preferred embodiment, such routed are set up by creating a string of “stops” creating a route, and giving timing for when those stops should be encountered. FIG. 6 depicts an example screen which allows such stops to be organized and edited. existing stops may then be strung together into new routes.

In the preferred embodiment, management will have the ability to set patrol routes for a guard to follow during a shift. In some embodiments, the application 450 will simply display these routes either through description or by a visual means such as a map. If location is available to the mobile application 450, the map can be updated with the current location of the guard much like a modern GPS guidance device.

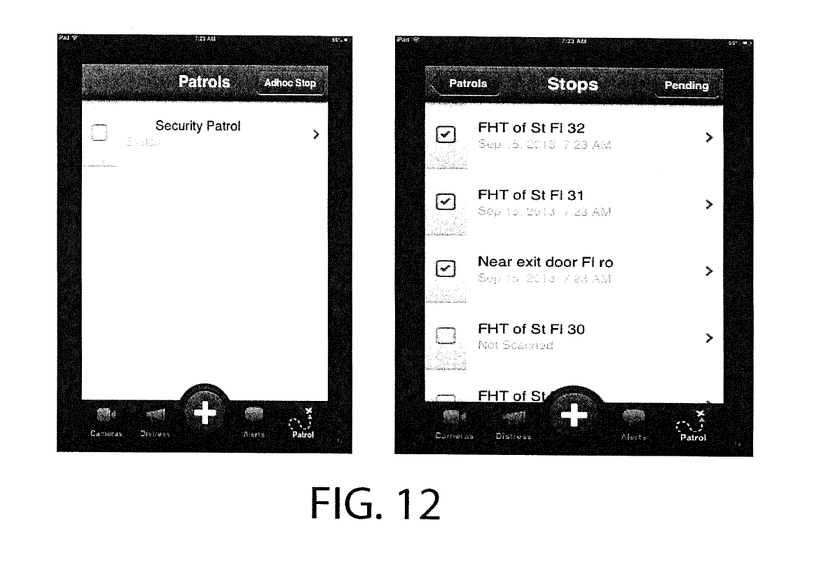

In the preferred embodiment, the application 450 will be able to determine and log both if the stops have been reached and at what time through location based tagging 264. FIG. 12 depicts an example interface for the application showing a sample security patrol where a number of stops have been checked off.

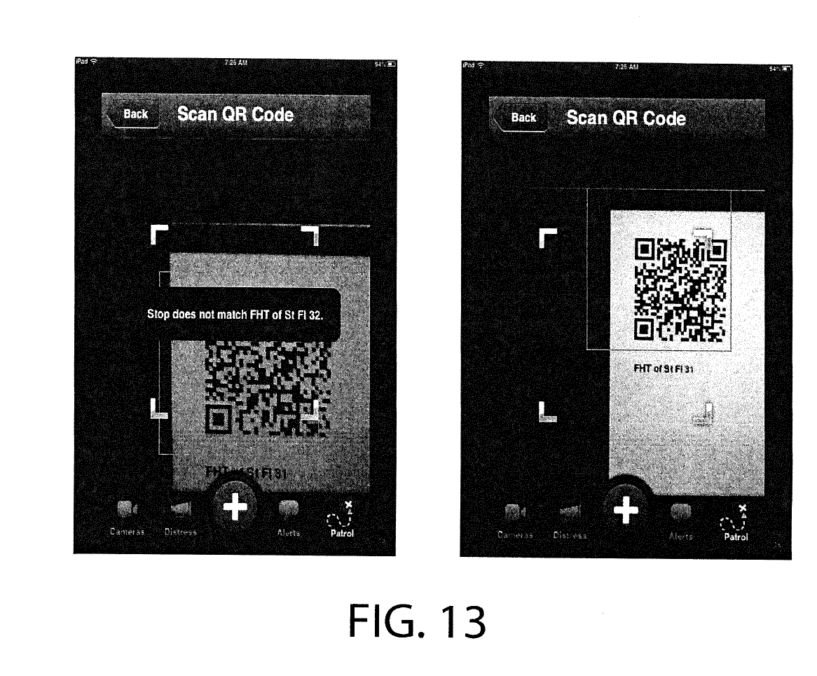

There are a number of ways in which the application can be configured to determine whether or not a guard has reached a stop, including: having the guard take a picture of a QR code at the stop, registering a GPS location, having the device use near field communications NFC to scan an installed NFC chip at the stop, or registering a location based on other triangulation means such as distance to Wi-Fi hotspots. FIG. 13 depicts an example interface for the application showing the interface to scan a QR code to register a stop.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention,

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

1. A system for performing security tasks comprising:
a networked server device;
one or more user operable electronic devices connected to the networked server via a network protocol;
one or more cameras connected to the networked server via a network means; and
an application installed on the networked server device allowing security tasks to be performed.

2. The system for performing security tasks of claim 1, wherein the one or more of the user operable electronic devices is a mobile device.

3. The system for performing security tasks of claim 1, wherein the one or more of the user operable electronic devices is a smartphone.

4. The system for performing security tasks of claim 1, wherein the networked server device is cloud based.

5. The system for performing security tasks of claim 1, wherein the security tasks which the application perform include one or more of the following:
user authentication;
voice communication;
messaging;
distress signaling;
video capture;
photo capture;
video playback;
location based tagging; or
incident reporting.

6. A system for setting and monitoring security guard patrol routes comprising:
a networked server device;
one or more mobile devices connected to the networked server via a network protocol; and
an application installed on the mobile devices which allows confirmation of the mobile devices process on a set patrol rout through geo-location.

7. The system of claim 6, where the geo-location comprises one or of the following:
scanning a QR code;
determining GPS coordinates; or
reading a NFC device.

8. A mobile CCTV camera monitoring system for a property comprising:
at least one CCTV camera system located on said property;
at least one mobile device for monitoring said CCTV camera system; and
a server system operably connected to both said CCTV camera system and said mobile device;
wherein said mobile device can selectively view said CCTV camera.

9. The mobile CCTV camera monitoring system of claim 8, wherein said CCTV camera system comprises:
a plurality of CCTV cameras; and
a DVR recording system;
wherein said CCTV cameras are each operably connected to said DVR recording system.

10. The mobile CCTV camera monitoring system of claim 9, wherein said DVR recording system comprises:
a video and/or image recorder;
a communication system; and
a control system operably connected to both said video and/or image recorder and such communication system;
wherein requests for video and/or images stored on said video and/or image recorder received by said communication system can be retrieved by said control system and transmitted by said communication system.

11. The mobile CCTV camera monitoring system of claim 9, wherein said mobile device comprises:
a communications system;
a CCTV camera application; and
an operating system;
wherein said CCTV camera application makes requests for video and or images to said operating system, said operating system sends such requests by means of such communications system to said server system, said server system requests said CCTV camera system to provide such video/images to said CCTV camera application.

12. The mobile CCTV camera monitoring system of claim 8, further comprising:
a user authentication and identification system running on said server; and
one or more user identifiers with particular video feed allowances contained in the user authentication system.

13. A system for providing CCTV video and/or performing security related tasks, comprising:
a mobile device;
a software application installed on the mobile device; and
a user identification system connected operably to the mobile device;
wherein said application is capable of displaying CCTV feeds and/or performing security guard related functions, depending on the identity of the user.

14. The system for providing CCTV video and/pr performing security related tasks, further comprising:
a user hierarchy wherein a user is assigned a rank or designation in a hierarchy which grants the user access to a certain set of CCTV video based on its position in the hierarchy.

15. A system whereby mobile devices are used to perform and monitor guard duties comprising:
a mobile device;
a system allowing guard routes to be set and monitored by location based logging, running on the mobile device;
a communication system running on the mobile device; and
a distress system running on the mobile device.

16. The system for performing security duties of claim 15, wherein the security duties which the application perform include one or more of the following:
user authentication;
voice communication;
text messaging;
video capture;
photo capture;
video playback;
location based tagging; or
incident reporting.
